(19) United States
(12) Patent Application Publication
(10) Pub. No.: US 2025/0172733 A1
(43) Pub. Date: May 29, 2025

(54) FRONT LIGHT MODULE AND DISPLAY DEVICE

(71) Applicant: Coretronic Corporation, Hsin-Chu (TW)

(72) Inventors: TZENG-KE SHIAU, Hsin-Chu (TW); YING-SHUN SYU, Hsin-Chu (TW); CHIN-YUAN CHANG, Hsin-Chu (TW)

(21) Appl. No.: 18/954,571

(22) Filed: Nov. 21, 2024

(30) Foreign Application Priority Data
Nov. 24, 2023 (CN) 202323178784.0

(51) Int. Cl. F21V 8/00; G02F 1/1335; G02F 1/13357

(52) U.S. Cl. CPC G02B 6/0016; G02F 1/133562; G02F 1/133615

(57) ABSTRACT

A front light module includes a light-emitting element and a light-guide assembly. The light-guide assembly includes a light guide plate and a light guide element. The light guide plate has a first side surface and a first surface connected to the first side surface. The first side surface faces the light-emitting element. A ratio of a projection area of the light guide element on the first surface to an area of the first surface is greater than 0.8. The light guide plate has a first thickness, and the light guide element has a second thickness. The light-emitting element has a height in the direction. A sum of the first thickness and the second thickness is greater than or equal to the height, and a ratio of the first thickness to the height is less than or equal to 0.75 and greater than or equal to 0.5.

### CROSS-REFERENCE TO RELATED APPLICATION

This application claims the priority benefit of the China application No. 202323178784.0, filed on Nov. 24, 2023. The entirety of the above-mentioned patent application is hereby incorporated by reference herein and made a part of this specification.

### TECHNICAL FIELD

The disclosure relates to a light source module, and more particularly to a front light module and a display device having the front light module.

### BACKGROUND

A reflective display device provided with a front light module utilizes ambient light as a light source to illuminate a reflective display panel to form display light which is transmitted to the eyes of a user. In an occasion where ambient light is insufficient, the front light module in front of the reflective display panel can be turned on to supplement light intensity. The front light module can expand the applicable scenarios of the reflective display device. However, to improve the light use efficiency, the light guide plate of the front light module is developed in a thinning trend at present. However, restricted by the service life and size of the light-emitting element of the front light module (the service life of a miniaturized light-emitting element is poor), the thickness of the light guide plate cannot be effectively reduced. Therefore, selectable assemblies are restricted.

The information disclosed in this “BACKGROUND” section is only for enhancement understanding of the background and therefore it may contain information that does not form the prior art that is already known to a person of ordinary skill in the art. Furthermore, the information disclosed in this “BACKGROUND” section does not mean that one or more problems to be solved by one or more embodiments of the disclosure were acknowledged by a person of ordinary skill in the art.

### SUMMARY

In order to achieve one or a portion of or all of the objectives or other objectives, the front light module in an embodiment of the disclosure includes a light-emitting element and a light-guide assembly. The light-guide assembly includes a light guide plate and a light guide element. The light guide plate has a first side surface and a first surface connected to each other. The first side surface faces the light-emitting element. The light guide element is disposed on the first surface, and a ratio of a projection area of the light guide element on the first surface to an area of the first surface is greater than 0.8. The light guide plate has a first thickness in a direction, and the light guide element has a second thickness in the direction. The light-emitting element has a height in the direction, and the direction is parallel to the normal to the first surface. A sum of the first thickness and the second thickness is larger than or equal to the height, and a ratio of the first thickness to the height is less than or equal to 0.85 and greater than or equal to 0.3.

In order to achieve one or a portion of or all of the objectives or other objectives, the display device in an embodiment of the disclosure includes the front light module and a reflective display panel. The reflective display panel is disposed opposite to the front light module.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic cross-sectional diagram of a front light module in an embodiment of the disclosure;

FIG. 2 is a schematic top view where a light guide element in FIG. 1 is disposed on a light guide plate;

FIG. 3 is a schematic cross-sectional diagram of a front light module in another embodiment of the disclosure;

FIG. 4 is a schematic cross-sectional diagram of a front light module in another embodiment of the disclosure;

FIG. 5 is a schematic cross-sectional diagram of a front light module in another embodiment of the disclosure;

FIG. 6 is a schematic cross-sectional diagram of a front light module in another embodiment of the disclosure;

FIG. 7 is a schematic cross-sectional diagram of a display device in an embodiment of the disclosure; and

FIG. 8 is a schematic cross-sectional diagram of a display device in another embodiment of the disclosure.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the disclosure may be practiced. In this regard, directional terminology, such as “top”, “bottom”, “front”, “back”, etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

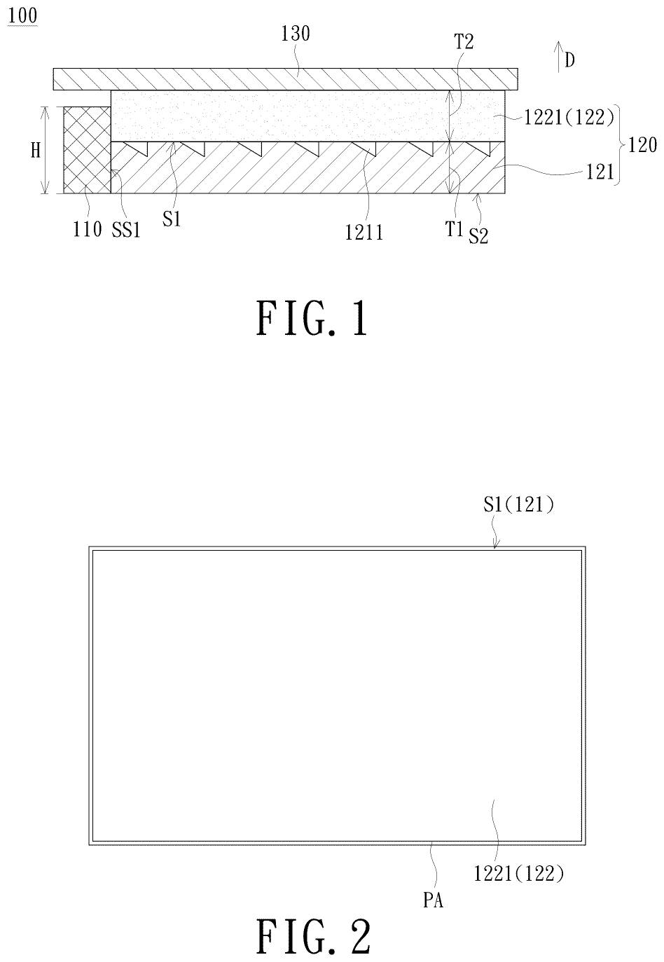

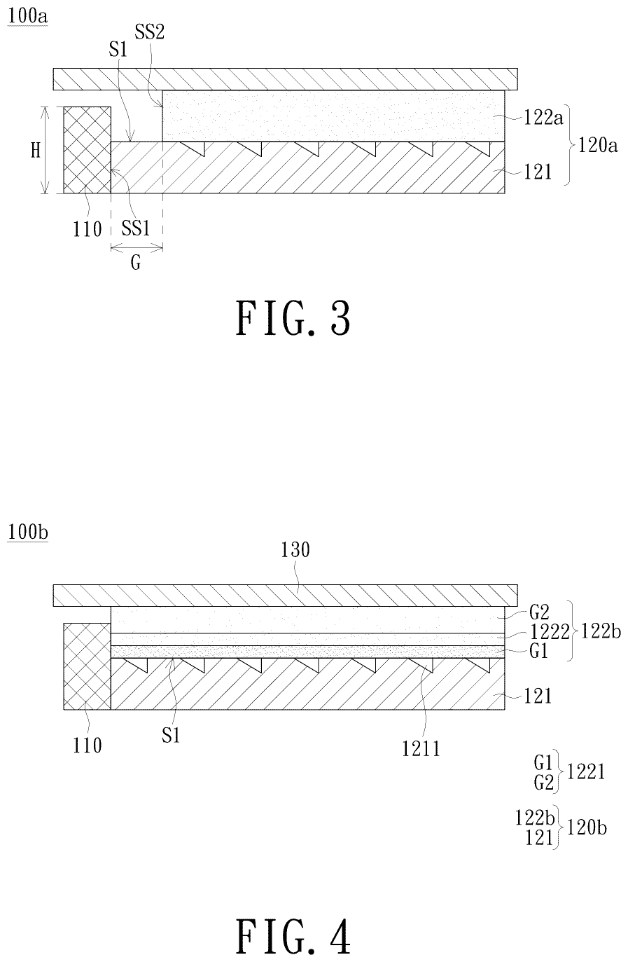

FIG. 1 is a schematic cross-sectional diagram of a front light module in an embodiment of the disclosure. FIG. 2 is a schematic top view where a light guide element in FIG. 1 is disposed on a light guide plate. Referring to FIG. 1 and FIG. 2, a front light module 100 includes a light-emitting element 110 and a light-guide assembly 120. The light-guide assembly 120 includes a light guide plate 121 and a light guide element 122. The light guide plate 121 has a first side surface SS1 and a first surface S1 connected to each other. The first side surface SS1 faces the light-emitting element 110. The light guide element 122 is disposed on the first surface S1, and a ratio of a projection area PA of the light guide element 122 on the first surface S1 of the light guide plate 121 to an area of the first surface S1 is greater than 0.8 (as shown in FIG. 2). For example, the aforementioned ratio in the embodiment may approximately be 1 (e.g., 0.95). In FIG. 2, the edge of the light guide element 122 is drawn to be slightly separated from the edge of the first surface S1 to clearly represent the projection area PA. In the subsequent embodiment in FIG. 3, the aforementioned ratio may be greater than 0.8 but less than 1. Referring to FIG. 1 again, the light guide plate 121 in the embodiment has a first thickness T1 in a direction D, and the light guide element 122 has a second thickness T2 in the direction D. The light-emitting element 110 has a height H in the direction D. It is to be noted that the direction D is parallel to a normal of the first surface S1. The sum of the first thickness T1 and the second thickness T2 is greater than or equal to the height H, and the ratio of the first thickness T1 to the height H is less than or equal to 0.85 and greater than or equal to 0.3.

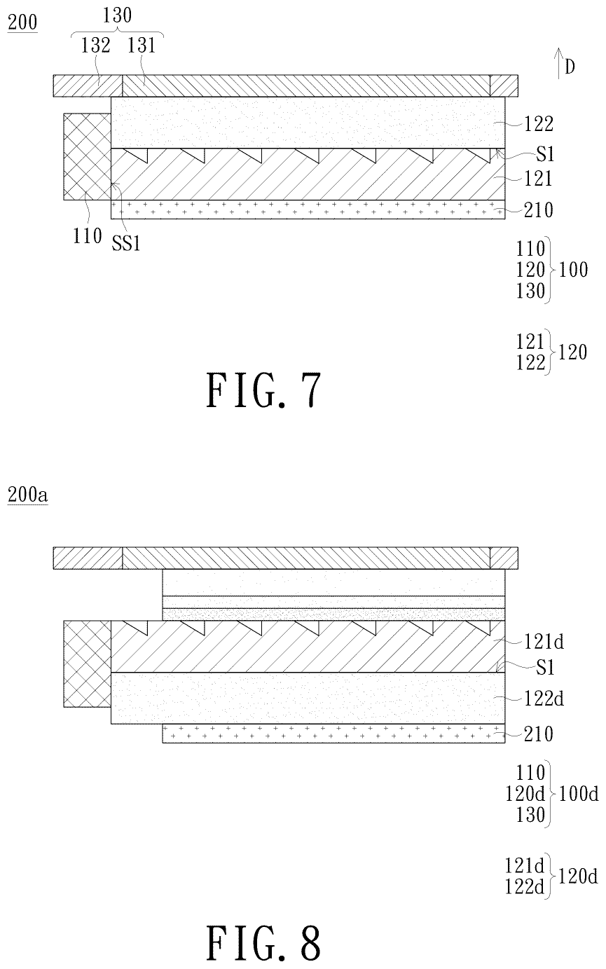

Continuously referring to FIG. 1, the light-emitting element 110 includes, for example, a light-emitting diode, but the disclosure is not limited thereto. The light-emitting element 110 in the embodiment can emit a light beam toward the light-guide assembly 120, and the aforementioned light beam may be guided by the light guide plate 121 and the light guide element 122 to be emitted from the front light module 100. In detail, the light beam generated by the light-emitting element 110 can be first guided by the light-guide assembly 120 to be emitted from a second surface S2 of the light guide plate 121, and is then reflected by a reflective display panel (shown in FIG. 7) and enters the front light module 100 (e.g., light guide plate 121) via the second surface S2. The second surface S2 and the first surface S1 of the light guide plate 121 are opposite to each other. The characteristics of the aforementioned reflective display panel will be described in subsequent paragraphs. Incidentally, the light-emitting element 110 can provide the aforementioned light beam in a case where the ambient light is insufficient.

The total thickness of the light-guide assembly 120 is the sum of the first thickness T1 and the second thickness T2. Because the aforementioned total thickness can be greater than or equal to the height H of the light-emitting element 110, the light beam generated by the light-emitting element 110 can sufficiently enter the light-guide assembly 120 so that the light beam generated by the light-emitting element 110 is fully utilized on the premise of reducing the first thickness T1 of the light guide plate 121. In an embodiment, the first thickness T1 and the second thickness T2 can be 0.2 mm, respectively, which is not over-limited in the disclosure.

In the embodiment, the material of the light guide plate 121 can include polymethyl methacrylate (PMMA). However, the material of the light guide plate 121 can include a cycloolefin polymer (COP) or polycarbonate (PC) in other embodiments. The light guide element 122 can be an adhesive layer 1221. In addition, the light guide plate 121 can be formed by way of hot press molding or injection molding, which is not over-limited in the disclosure. In the embodiment, the refractive index of the light guide plate 121 can be greater than the refractive index of the light guide element 122 (i.e., adhesive layer 1221). Therefore, more light beams generated by the light-emitting element 110 can be transmitted in a direction away from the light-emitting element 110 in the light guide plate 121 (for example, the light beams are subjected to total internal reflection on the first surface S1 and the second surface S2), so that the light use efficiency is further improved and the optical features of the front light module 100 can further be improved. For example, in an embodiment, the refractive index of the light guide plate 121 can approximately be between 1.4 and 1.6, which is not over-limited in the disclosure.

In the embodiment, the light guide element 122 can not only guide the light beam together with the light guide plate 121 but also fix other components on the light guide plate 121. For example, the front light module 100 can further include a light-transmitting cover plate 130, where the light guide element 122 (e.g., adhesive layer 1221) is disposed between the light-transmitting cover plate 130 and the light guide plate 121. The material of the light-transmitting cover plate 130 can include glass, plastic or other transparent material, but the disclosure is not limited thereto. Further, the two surfaces of the adhesive layer 1221 are connected to the light-transmitting cover plate 130 and the first surface S1 of the light guide plate 121, respectively. In detail, the adhesive layer 1221 is disposed on the first surface S1. A part of light beams generated by the light-emitting element 110 can directly enter the light guide plate 121, and then be transmitted by the light guide plate 121 and the reflective display panel (shown in FIG. 7) to be incident to the adhesive layer 1221 via the first surface S1, and pass through the adhesive layer 1221 and the light-transmitting cover plate 130 and is then emitted out the front light module 100. On the other hand, another part of light beams generated by the light-emitting element 110 can directly enter the adhesive layer 1221, and is then transmitted by the adhesive layer 1221, the light guide plate 121, and the reflective display panel (drawn in FIG. 7) to be incident to the light-transmitting cover plate 130 via the adhesive layer 1221, and is then emitted from the light-transmitting cover plate 130. Therefore, the adhesive layer 1221 is not only connected to the light-transmitting cover plate 130 and the light guide plate 121 but also guides the light beam together with the light guide plate 121, so that the first thickness T1 of the light guide plate 121 is reduced to be less than the height H of the light-emitting element 110, and therefore the overall thickness of the front light module 100 is further reduced. Incidentally, the light guide plate 121 can further include a plurality of optical microstructures 1211, and the optical microstructures 1211 are disposed on the first surface S1. The optical microstructures 1211 are, for example, recessed in the first surface S1 and can reflect the light beam generated by the light-emitting element 110 to the second surface S2, so that the light beam is incident to the reflective display panel via the second surface S2.

Referring to FIG. 1 and FIG. 2 together again, the ratio of the projection area PA of the adhesive layer 1221 on the first surface S1 to the area of the first surface S1 is greater than 0.8. In other words, the adhesive layer 1221 can be disposed on the first surface S1 in a direct bonding manner rather than an air bonding manner, so as to conduct the light beam generated by the light-emitting element 110 sufficiently. In addition, because the adhesive layer 1221 fills the gap between the first surface S1 and the light-transmitting cover plate 130 more completely, the interfacial reflection formed by the ambient light entering the front light module 100 can further be reduced. Incidentally, the adhesive layer 1221 includes, for example, an optical clear adhesive (OCA), but the disclosure is not limited thereto.

Compared with the prior art, the front light module 100 in the embodiment uses the light-guide assembly 120 including the light guide plate 121 and the light guide element 122, where the total thickness of the light guide plate 121 and the light guide element 122 is greater than or equal to the height of the light-emitting element 110, and the light guide element 122 at least accounts for 80% of the area of the first surface S1, so as to guide the light beam generated by the light-emitting element 110 together with the light guide plate 121. Therefore, the first thickness T1 of the light guide plate 121 can be reduced, so that the weight of the front light module 100 is further reduced. Because the first thickness T1 of the light guide plate 121 can be no longer greater than or equal to the height H of the light-emitting element 110, the front light module 100 in the embodiment further has the advantage of flexible selection of specifications of the components. For example, it is not necessary to deliberately choose miniaturized light-emitting components.

FIG. 3 is a schematic cross-sectional diagram of a front light module in another embodiment of the disclosure. The structure and advantages of the front light module 100a in the embodiment are similar to those in the embodiment shown in FIG. 1, and only the differences will be described below. Referring to FIG. 3, the light guide element 122a of the light-guide assembly 120a has a second side surface SS2 facing the light-emitting element 110. The second side surface SS2 is non-parallel to the first surface S1 of the light guide plate 121, and there is a gap G between projection areas of the second side surface SS2 and the first side surface SS1 on the first surface S1. In short, the second side surface SS2 is, for example, perpendicular to the first surface S1 and is not flush with the first side surface SS1 of the light guide plate 121. In addition, the second side surface SS2 is farther away from the light-emitting element 110 compared with the first side surface SS1. Therefore, the light guide element 122a can be prevented from being attached to the light-emitting element 110 to affect the light-emitting uniformity of the front light module 100, so that the optical feature of the front light module 100a is further improved. In an embodiment, the gap G is, for example, less than or equal to 3 mm. In another embodiment, the gap G can be greater than or equal to 1 mm, but the disclosure does not over-limit the specific numerical values.

FIG. 4 is a schematic cross-sectional diagram of a front light module in another embodiment of the disclosure. The structure and advantages of the front light module 100b in the embodiment are similar to those in the embodiment shown in FIG. 1, and only the differences will be described below. Referring to FIG. 4, the light guide element 122b of the light-guide assembly 120b further includes, for example, an optical film 1222. The adhesive layer 1221 can include a first light-transmitting adhesive layer G1 and a second light-transmitting adhesive layer G2. The first light-transmitting adhesive layer G1 is connected to the first surface S1 and the optical film 1222, the optical film 1222 is disposed between the first light-transmitting adhesive layer G1 and the second light-transmitting adhesive layer G2, and the first light-transmitting adhesive layer G1 is disposed between the light guide plate 121 and the optical film 1222. Specifically, the first light-transmitting adhesive layer G1 can fix the optical film 1222 to the first surface S1, and the second light-transmitting adhesive layer G2 can fix the light-transmitting cover plate 130 to the optical film 1222. In addition, the material hardness of the optical film 1222 can be greater than the material hardness of the first light-transmitting adhesive layer G1 and the second light-transmitting adhesive layer G2 so that the first light-transmitting adhesive layer G1 is connected to the first surface S1 and the second light-transmitting adhesive layer G2 is connected to the light-transmitting cover plate 130. It is worth mentioning that because the optical microstructure 1211 is recessed in the first surface S1, the adhesive force and the thickness of the first light-transmitting adhesive layer G1 disposed on the first surface S1 can be less than those of the second light-transmitting adhesive layer G2 so that the amount of the first light-transmitting adhesive layer G1 recessed in the optical microstructure 1211 is reduced, and therefore the optical feature of the front light module 100b is further improved. In the embodiment, the optical film 1222 can include a transparent substrate or a polarizer. In an embodiment, the optical film 1222 can include the polarizer and/or an advanced polarization conversion film (APCF). However, the disclosure does not over-limit the specific type of the optical film 1222.

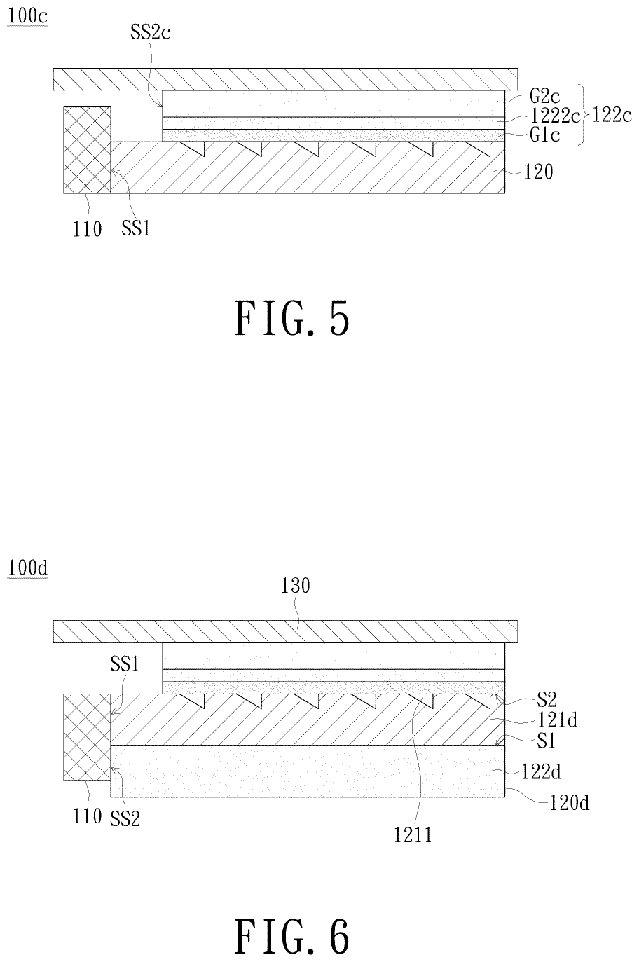

FIG. 5 is a schematic cross-sectional diagram of a front light module in another embodiment of the disclosure. The structure and advantages of the front light module 100c in the embodiment are similar to those in the embodiment shown in FIG. 4, and only the differences will be described below. Referring to FIG. 5, it is to be understood that the second side surface SS2c of the light guide element 122c may not be flush with the first side surface SS1, and the second side surface SS2c is farther away from the light-emitting element 110 compared with the first side surface SS1. Therefore, the first light-transmitting adhesive layer G1c and the second light-transmitting adhesive layer G2c can be prevented from being attached to the light-emitting element 110, so that the optical feature of the front light module 100c is further improved. In the embodiment, the sides, facing the light-emitting element 110, of the first light-transmitting adhesive layer G1c, the second light-transmitting adhesive layer G2c, and the optical film 1222c can be flush to form the second side surface SS2c. In an embodiment, the sides of the first light-transmitting adhesive layer G1c and the second light-transmitting adhesive layer G2c can be farther away from the light-emitting element 110 compared with the side of the optical film 1222c.

FIG. 6 is a schematic cross-sectional diagram of a front light module in another embodiment of the disclosure. The structure and advantages of the front light module 100d in the embodiment are similar to those in the embodiment shown in FIG. 1, and only the differences will be described below. Referring to FIG. 6, the second surface S2 and the first surface S1 of the light guide plate 121d are opposite to each other, and the second surface S2 faces the light-transmitting cover plate 130. The optical microstructure 1211 is disposed on the second surface S2, and the light guide element 122d is disposed on the first surface S1. In other words, because the first surface S1 is opposite to the light-transmitting cover plate 130, the light guide element 122d is disposed on the side, opposite to the light-transmitting cover plate 130, of the light guide plate 121d. In the embodiment, the light guide element 122d of the light-guide assembly 120d includes, for example, an adhesive layer. The adhesive layer can include an optical clear adhesive, which is not over-limited in the disclosure. Similarly, in an embodiment, the second side surface SS2 of the light guide element 122d cannot be flush with the first side surface SS1, and the second side surface SS2 is farther away from the light-emitting element 110 compared with the first side surface SS1.

FIG. 7 is a schematic cross-sectional diagram of a display device in an embodiment of the disclosure. Referring to FIG. 7, the display device 200 includes the front light module 100 and the reflective display panel 210. The reflective display panel 210 is overlapped with the front light module 100. For example, the light guide plate 121 is sandwiched between the light guide element 122 and the reflective display panel 210. The front light module 100 is similar to the embodiment shown in FIG. 1, which is not repeatedly described herein.

The reflective display panel 210 can reflect the ambient light or the light beam generated by the light-emitting element 110, so as to achieve the effect of displaying an image. Specifically, when the ambient light is sufficient, the ambient light can pass through the light-guide assembly 120 and then be incident to the reflective display panel 210, and the reflective display panel 210 can display the image by reflecting the ambient light. On the contrary, when the ambient light is insufficient, the light beam generated by the light-emitting element 110 can be incident to the reflective display panel 210 via the light-guide assembly 120, and the reflective display panel 210 can display the image by reflecting the ambient light. The reflective display panel 210 can include a liquid crystal on silicon (LCOS), which is not limited in the disclosure. In addition, in the embodiment, the reflective display panel 210 can be a monochromatic grayscale display panel or a colored display panel. Further, the display device 200 can include an electronic paper display device, which is not over-limited in the disclosure.

Incidentally, the light-transmitting cover plate 130 in the embodiment can include a light-transmitting area 131 and a light shading area 132, where the reflective display panel 210 is overlapped in the light-transmitting area 131 in the direction D. In addition, the light guide element 122 is overlapped in the light-transmitting area 131 and a part of the light shading area 132 in the direction D. Therefore, the light beam emitted from the reflective display panel 210 can pass through the light-transmitting area 131 to display the image.

Compared with the prior art, the display device 200 in the embodiment uses the front light module 100, so that it has the advantage of being lighter and flexible selection of specifications of the assemblies. It is to be understood that in other embodiments, the display device 200 in FIG. 7 can use the front light modules 100a, 100b, 100c, or 100d.

FIG. 8 is a schematic cross-sectional diagram of a display device in another embodiment of the disclosure. The structure and advantages of the display device 200a in the embodiment are similar to those in the embodiment shown in FIG. 7, and only the differences will be described below. Referring to FIG. 8, the display device 200a can use the front light module 100d in FIG. 6. Further, the first surface S1 of the light guide plate 121d faces the reflective display panel 210, and the light guide element 122d is sandwiched between the light guide plate 121d and the reflective display panel 210. In the embodiment, the light guide element 122d can include an adhesive layer, and the reflective display panel 210 can be fixed to the first surface S1 by the adhesive layer. Other characteristics of the front light module 100d are as described above, and therefore no redundant detail is to be given herein.

In summary, the front light module of an embodiment of the disclosure at least has one of the following advantages. The front light module provided by the disclosure uses a light-guide assembly including the light guide plate and the light guide element, where the total thickness of the light guide plate and the light guide element is greater than or equal to the height of the light-emitting element, and the light guide element at least accounts for 80% of the area of the first surface, so as to, together with the light guide plate, guide the light beam of the light-emitting element to be emitted from the front light module. Therefore, the first thickness of the light guide plate can be reduced, so that the weight of the front light module is further reduced. Because the first thickness of the light guide plate is not limited being greater than or equal to the height of the light-emitting element, the front light module provided by the disclosure further has the advantage of flexible selection of specifications of the assemblies. The display device provided by the disclosure uses the front light module so that it has the advantage of light weight and flexible selection of specifications of the assemblies.

The foregoing description of the preferred embodiment of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure” is not necessary limited the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless a specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. A front light module, comprising:
a light-emitting element;
a light-guide assembly, comprising a light guide plate and a light guide element, wherein the light guide plate has a first side surface and a first surface connected to the first side surface, the first side surface faces the light-emitting element, the light guide element is disposed on the first surface, a ratio of a projection area of the light guide element on the first surface to an area of the first surface is greater than 0.8, the light guide plate has a first thickness in a direction, the light guide element has a second thickness in the direction, the light-emitting element has a height in the direction, the direction is parallel to a normal of the first surface, a sum of the first thickness and the second thickness is greater than or equal to the height, and a ratio of the first thickness to the height is less than or equal to 0.75 and greater than or equal to 0.5.

2. The front light module according to claim 1, wherein the light guide element comprises an adhesive layer, the adhesive layer has a second side surface facing the light-emitting element, the second side surface is non-parallel to the first surface, and there is a gap between projection areas of the second side surface and the first side surface on the first surface.

3. The front light module according to claim 2, wherein the gap is less than or equal to 3 mm.

4. The front light module according to claim 1, wherein a refractive index of the light guide plate is greater than a refractive index of the light guide element.

5. The front light module according to claim 1, further comprising a light-transmitting cover plate, disposed between the light-transmitting cover plate and the light guide plate.

6. The front light module according to claim 5, wherein the light guide element is an adhesive layer, the adhesive layer is connected to the light-transmitting cover plate and the first surface of the light guide plate, and the light guide plate further comprises a plurality of optical microstructures disposed on the first surface.

7. The front light module according to claim 1, wherein the light guide element comprises an adhesive layer and an optical film, the adhesive layer comprises a first light-transmitting adhesive layer and a second light-transmitting adhesive layer, the first light-transmitting adhesive layer is connected to the first surface, the optical film is disposed between the first light-transmitting adhesive layer and the second light-transmitting adhesive layer, and the first light-transmitting adhesive layer is disposed between the light guide plate and the optical film.

8. The front light module according to claim 1, further comprising a light-transmitting cover plate, wherein the light guide plate further has a second surface and a plurality of optical microstructures, the second surface is opposite to the first surface, the second surface faces the light-transmitting cover plate, and the optical microstructures are disposed on the second surface.

9. A display device, comprising:
a front light module, comprising a light-emitting element and a light-guide assembly, wherein the light-guide assembly comprises a light guide plate and a light guide element, the light guide plate has a first side surface and a first surface connected to the first side surface, the first side surface faces the light-emitting element, the light guide element is disposed on the first surface, a ratio of a projection area of the light guide element on the first surface to an area of the first surface is greater than 0.8, the light guide plate has a first thickness in a direction, the light guide element has a second thickness in the direction, the light-emitting element has a height in the direction, the direction is parallel to a normal of the first surface, a sum of the first thickness and the second thickness is greater than or equal to the height, and a ratio of the first thickness to the height is less than or equal to 0.75 and greater than or equal to 0.5; and
a reflective display panel, disposed opposite to the front light module.

10. The display device according to claim 9, wherein the first surface faces away from the reflective display panel, and the light guide plate is sandwiched between the light guide element and the reflective display panel.

11. The display device according to claim 9, wherein the first surface faces the reflective display panel, and the light guide element is sandwiched between the light guide plate and the reflective display panel.
